(19) United States
(12) Patent Application Publication
(10) Pub. No.: US 2018/0356041 A1
(43) Pub. Date: Dec. 13, 2018

(54) THERMOCHROMIC INDICATOR FOR REAGENT GAS VESSEL

(71) Applicant: Entegris, Inc., Billerica, MA (US)

(72) Inventors: Joseph Despres, Middletown, CT (US); Edgar La Borde, Danbury, CT (US)

(21) Appl. No.: 16/002,916

(22) Filed: Jun. 7, 2018

Related U.S. Application Data
(60) Provisional application No. 62/518,172, filed on Jun. 12, 2017.

(51) Int. Cl. F17C 13/02; G01K 11/16; F17C 11/00

(52) U.S. Cl. CPC F17C 13/026; G01K 11/165; G01K 11/16; F17C 2205/0394; F17C 2270/0518; F17C 2201/0109; F17C 11/00

(57) ABSTRACT

A dispensing and storage vessel for use in housing a gas such as toxic and hazardous gas in combination with a temperature sensitive label is described. Example dispensing and storage vessels include an adsorbent and a reagent gas within an internal volume of the vessel. A thermochromic label is adhered to the vessel and communicates temperature-sensitive information in a visual fashion to a user.

### RELATED APPLICATION

This Application claims the benefit of and priority to U.S. Provisional Application No. 62/518,172 filed on Jun. 12, 2017, the entire contents of which are incorporated herein by reference in their entirety for all purposes.

### TECHNICAL FIELD

The disclosure relates to indicators for communicating information in a visual fashion, the information relating to a pressure of a reagent gas contained in a vessel.

### BACKGROUND

Toxic and other hazardous specialty gases are used in a number of industrial applications in various areas of manufacturing, such as in the manufacture of microelectronic, semiconductor, photovoltaic, and flat-panel display products. Examples of specific processes that involve hazardous specialty gases as raw materials include processes for ion implantation, epitaxial growth, plasma etching, reactive ion etching, metallization, physical vapor deposition, chemical vapor deposition, photolithography, cleaning, and doping.

Various specialty gases are considered to be hazardous due to known properties of toxicity, flammability, or pyrophoricity. A leak of a hazardous specialty gas may cause headache, nausea, vertigo, anemia, nephropathy, diarrhea, dyspnea, muscle pains, pulmonary edema, frostbite, and even death, to an exposed person. These specialty gases may also be highly corrosive, spontaneously flammable in air, or exhibit other dangerous effects. The sensitive and expensive processing equipment and in-process items of manufacture (e.g., silicon wafers, microelectronic devices, and the like) to which these gases are supplied for use may also be damaged by exposure to even trace amounts of certain types of hazardous gases.

Due to their hazardous nature, an accidental or inadvertent release of a hazardous specialty gas results in a partial or complete evacuation of the environment of the leak. In addition to the risk of potential injury or sickness to those exposed to the leak, and the possibility of damage to equipment or manufactured items, lost time and productivity will also result from an evacuated work facility in the result of a hazardous gas leak.

Knowing of the potential costs and risks of a hazardous gas leak, many varieties of containers to safely contain hazardous gases have been studied and developed, to allow for the safe storage, transport, and use of hazardous gases. Varieties of containers include pressurized containers and sub-atmospheric containers, meaning containers designed to store a hazardous gas at a pressure that is above or below one atmosphere (absolute).

Some examples of containers used to store hazardous specialty gases are those that contain a fluid at super-atmospheric pressure and are pressure-regulated to dispense the fluid from the container at a desired pressure. A fluid (gas) supply vessel will contain the gas at greater than atmospheric pressure. A pressure-regulation system that may include one or multiple pressure regulators (and optional flow regulators) can be arranged internal or external to the vessel. A set point of a pressure for dispensing the gas may be super-atmospheric, sub-atmospheric, or atmospheric pressure, as desired.

Other examples of systems and containers for storing and handling hazard specialty gases are adsorbent-based fluid supply systems. These systems involve a vessel that contains the gas, and an adsorbent storage medium for adsorptive retention of the gas. The gas can be selectively adsorbed and desorbed from the adsorbent, such as by control of temperature or pressure of the system. An advantage of adsorbent-type systems is that they are capable of storing useful amounts of adsorbed gas at sub-atmospheric pressure. With the hazardous gas contained in the vessel at sub-atmospheric pressure, an accidental or inadvertent breach of the vessel involves a reduced safety risk—the contained hazardous gas, not being pressurized, i.e., having a pressure below one atmosphere, is less prone to escape the container into a working environment that is at ambient pressure of about one atmosphere (absolute). Examples of adsorbent-based fluid supply systems and containers include products commercially available from Entegris, Inc., Billerica, Mass., USA, e.g., under the trademarks SDS, PDS, and SAGE.

Manufacturing in the areas of microelectronic and semiconductor devices, flat panel displays, solar panels, and other types of commercial and industrial technologies that involve the use of hazardous gases as a raw material require that hazardous reagent gases be used, handled, stored, and processed in ways that are as safe as possible. New systems and methods for reducing the level of risk when handling hazardous reagent gases are in continuous demand.

### SUMMARY

The present disclosure relates to vessels for containing reagent gas having a thermochromic indicator; to methods of conveying information about the pressure of gaseous contents within a vessel to a location that is external to the vessel; and to related methods for handling, storing, using, and supplying hazardous reagent gases with an increased level of safety.

According to the disclosure, methods have been identified to visually communicate information relating to a pressure of a contained reagent gas, based on the temperature of the gas or the vessel that contains the gas.

For safety reasons, a contained (“reagent”) gas in a storage and delivery vessel may be contained in the vessel with gas being present at a pressure that is below a pressure that is pre-determined to be a desired maximum pressure. The desired maximum pressure can be associated with a temperature at which the maximum pressure will occur within the vessel. According to the disclosure, a thermochromic indicator can be included with a vessel to indicate visually whether a pressure within the vessel is above or below the desired maximum pressure. The temperature at which the desired maximum pressure is reached within the vessel can be considered to be a “transition temperature.” The term “transition temperature, as used herein, is a pre-selected temperature at which a gas passes from a desired, recommended, safe or otherwise suitable pressure within a vessel, to a pressure that is undesirably high, for any reason, such as for a safety reason. The thermochromic indicator can change from a temperature at which the desired maximum pressure occurs (e.g., a transition temperature), taking on a first appearance at a temperature that is below the temperature associated with the desired maximum pressure, and taking on a second appearance when the temperature of the vessel exceeds the desired maximum pressure. The thermochromic indicator communicates information relating to the internal pressure of a vessel in a visual fashion, thus allowing for a specific response from a user or handler of the vessel in real time. According to the disclosure, a thermochromic indicator can be useful to convey to a user a risk of over-pressurization of a vessel due to a temperature that results in an undesirably high pressure of gas in the vessel, instructing the user to reduce the temperature of the vessel to return the gas within the vessel to a desirably low (e.g., recommended) pressure.

The vessel of the present description, used in combination with a thermochromic indicator as described, can be at any pressure. The desired maximum pressure (and a related transition temperature) can relate to any one of: a pressure that is recommended due safety; a pressure that is recommended for use of a gas in a certain type of process or with a certain type of processing tool; or for any other reason that would be a basis for a recommended maximum pressure for a gas contained in a vessel. While the following description relates in large part to a vessel that contains adsorbed reagent gas at a moderate pressure (e.g., at about one atmosphere), and uses atmospheric pressure as a transition temperature, the present description and disclosure are not limited to such vessels or transition temperatures. The thermal indicators and methods, as described according to the various embodiments, also can be used with vessels having any other (substantially greater) internal pressure and that involve a different (e.g., higher or lower) transition temperature.

Certain example embodiments of the disclosure relate to systems and containers (i.e., vessels) that contain adsorbent to store a reagent gas, desirably at a pressure below one atmosphere (i.e., at sub-atmospheric pressure). These example vessels may contain reagent gas that may be toxic or otherwise hazardous to the health or safety of humans, or damaging to sensitive equipment or manufactured products (e.g., microelectronic devices, semiconductor devices, flat-panel display components, solar panel components, or other similar items).

In example vessels, the gas is present in the vessel, in part, as an adsorbed reagent gas that is adsorbed onto the adsorbent. The gas is also present, in part, in equilibrium with the adsorbed reagent gas, as a non-adsorbed reagent gas (i.e., gaseous reagent gas) in gaseous form at the interior of the vessel. These example vessels may contain no measurable portion or amount of the reagent gas in liquid form. The amount of the portion of the reagent gas that is present in the form of gaseous reagent gas, as compared to the portion of the reagent gas that is present in the form of adsorbed reagent gas, depends in part on the temperature of the system. At a relatively higher system temperature, a larger portion of the reagent gas will exist in the form of gaseous reagent gas, with an attendant increase in pressure within the container. At a relatively lower system temperature, a larger portion of the reagent gas will exist in the form of an adsorbed agent gas.

For safety reasons, certain types of reagent gases can be desirably contained in a vessel with the gaseous reagent gas being present at a pressure that is below atmospheric pressure (e.g. sub-atmospheric pressure). The temperature and temperature range at which a specific reagent gas in a vessel with a specific adsorbent will be at a super-atmospheric pressure, or at a sub-atmospheric pressure, will depend on the system of the specific reagent gas and the specific adsorbent. As used herein, a temperature at which a gaseous reagent gas (e.g., in substantially pure form) in a closed vessel with an adsorbent will be at a pressure that is greater than atmospheric pressure (absolute) is referred to as a super-atmospheric temperature or “T_{Sup}. ” Also, as used herein, a temperature at which a reagent gas (e.g., in substantially pure form) in a closed vessel with an adsorbent will be at a pressure that is below one atmosphere (absolute) is referred to as a sub-atmospheric temperature or “T_{Sub}.” In these systems, a temperature at which a reagent gas (e.g., that is substantially pure) in a closed vessel with an adsorbent is at one atmosphere (absolute) can be referred to as a transition temperature or “T_{Tra}.”

During preparation, transport, storage, and use, the pressure of the reagent gas in these types of closed vessels can preferably be maintained at below one atmosphere, absolute, i.e., be maintained at a sub-atmospheric pressure, or at a safe margin below one atmosphere such as at a pressure of 0.95, 0.9, or 0.8 atmosphere (absolute). To achieve this internal pressure of the reagent gas, the temperature of the system, including the vessel, adsorbent, and the reagent gas (adsorbed and gaseous) can be maintained at a temperature that is below the TTra for the system, here, one atmosphere. According to various embodiments, the vessels, according to various embodiments of the disclosure, permit a user to monitor the pressure of reagent gas at an interior of a vessel to determine by use of visual information located at the exterior of the vessel whether or not reagent gas contained in the vessel is at a pressure that is above or below a transition temperature, e.g., at a super-atmospheric pressure or at a sub-atmospheric pressure. The vessels, according to the various embodiments as described herein, include a thermochromic indicator in thermal communication with the vessel. The thermochromic indicator indicates when the system, e.g., one or more of the vessel (sidewalls), adsorbed reagent gas contained in the vessel, and gaseous reagent gas contained in the vessel, is at a super-atmospheric temperature, T_{Sup}, i.e., a temperature that is greater than T_{Tra}.

According to example systems, a storage and dispensing vessel for storing and dispensing a reagent gas, especially a reagent gas that is a hazardous reagent gas, can include an interior volume, an adsorbent within the interior volume, a reagent gas within the interior volume, a gaseous fluid flow port, an exterior surface, and a reversible thermochromic indicator at the exterior surface and in thermal contact with the vessel. The reagent gas is in a form that includes a portion that is adsorbed on the adsorbent as adsorbed reagent gas, and a portion that is present as gaseous reagent gas in equilibrium with the adsorbed reagent gas. Over a range of ambient operating temperatures (e.g., temperatures in a range from about 0 degrees Celsius to about 30, 35 or 40 degrees Celsius) these example vessels (i.e., the gaseous reagent gas) are not highly pressurized and preferably contain reagent gas at a pressure that is in a range of about one atmosphere (absolute), e.g., in a range of 0.5 to 1.5, 2.0 or 3.0 atmospheres (absolute). The thermochromic indicator reversibly indicates whether gaseous reagent gas contained in the vessel is above or below an “atmospheric temperature” T_{Tra}, i.e., is at a super-atmospheric temperature T_{Sup} at which gaseous reagent gas is at a super-atmospheric pressure, or is at a sub-atmospheric temperature T_{Sub} at which the gaseous reagent gas is at a sub-atmospheric pressure.

Advantageously, the thermochromic indicator communicates information relating to the internal pressure of a vessel in a visual fashion, thus allowing for a specific response from a user or handler of the vessel in real time. According to the disclosure, a thermochromic indicator can be useful to convey to a user a risk of over-pressurization of a vessel due to a temperature that exceeds a transition temperature, e.g., that results in a pressure that is greater than a desired maximum pressure (such as a super-atmospheric pressure) of gaseous reagent gas in the vessel, allowing or instructing the user to reduce the temperature of the vessel to return the reagent gas within the vessel to a sub-atmospheric pressure.

The thermochromic indicator can be prepared by use of any temperature-indicative material, especially a reversible temperature-indicative material that is capable of repeatedly changing appearance (e.g., color, opacity) when passing from a temperature that is above an activation temperature to a temperature that is below an activation temperature and vice-versa. Specific non-limiting examples of useful temperature-indicative materials include leuco-dyes that reversibly changes color passed below or above an activation temperature. Alternate temperature-indicative materials include liquid crystal temperature-indicative materials, such as liquid crystal slurries that change color within a spectrum and communicate temperature and temperature changes based on an appearance (e.g., color) of the temperature-indicative material at different temperatures.

The temperature-indicative material can be selected to change color at a desired temperature, within a range of operating temperatures (e.g., from 30 or 40 degrees Fahrenheit to 70, 80, or 90 degrees Fahrenheit). The temperature at which the temperature-indicative material changes appearance (e.g., color) can be referred to as the “activation temperature” of the temperature-indicative material. According to the present description, an activation temperature can be selected to be equal to or approximately equal to (e.g., slightly below) a transition temperature (T_{Tra}) of a reagent gas in a vessel, one example being a temperature at which the reagent gas passes from a sub-atmospheric pressure T_{Sub}, to a super-atmospheric pressure Tsup. Optionally, as an added margin of safety, the activation temperature can be selected to be slightly below the transition temperature, such as at a temperature at which the reagent gas will be at pressure of 0.8, 0.85, 0.9, or 0.95 atmosphere.

Examples of transition temperatures may be temperatures that are at or about an operating temperature used for a vessel, or, for added safety, a few to several degrees (Celsius) above the operating temperature of the vessel. An operating temperature may be any temperature at which reagent gas is used, with a non-limiting range being from 0 degrees Celsius to 40 degrees Celsius, e.g., from 5 to 35 or from 10 to 30 degrees Celsius; for many applications of reagent gases, an operating temperature can be in a range from 20 to 29° C. A transition temperature can be a temperature that is within a range about, or approximately the same as an operating temperature for a vessel, or at a higher end or slightly above a higher endpoint of a range of operating temperature of a particular vessel and reagent gas. For a vessel that is used at an operating temperature of about normal room temperature, e.g., about 24 degrees Celsius, a transition temperature can be a temperature that is about 24 degrees Celsius, or slightly higher, e.g., 25, 26, 27, 28, or 29 degrees Celsius. When the vessel temperature is below the transition temperature, a thermochromic indicator as described has a first appearance (e.g., color or the presence of text or a symbol), and when the vessel temperature is above the transition temperature the indicator has a second appearance (e.g., color or the presence of a text or symbol).

In one aspect, the disclosure relates to a storage and dispensing vessel for storing and dispensing reagent gas. The vessel includes: an interior volume; adsorbent within the interior volume; reagent gas within the interior volume, the reagent gas comprising a portion that is adsorbed on the adsorbent as adsorbed reagent gas, and a portion that is present as gaseous reagent gas in equilibrium with the adsorbed reagent gas; an exterior surface; and a reversible thermochromic indicator in thermal contact with the exterior surface, the thermochromic indicator reversibly indicating whether an interior pressure of the vessel is above a desired maximum pressure that is associated with a transition temperature.

In another aspect, the disclosure relates to a storage and dispensing vessel for storing and dispensing a reagent gas. The vessel includes: an interior volume; adsorbent within the interior volume, the adsorbent having sorptive affinity for reagent gas, to contain the sorptive gas as adsorbed reagent gas on the adsorbent in equilibrium with gaseous sorptive gas at the interior; a gaseous fluid flow port; an exterior surface; and a reversible thermochromic indicator in thermal contact with the exterior surface, the thermochromic indicator being capable of reversibly indicating whether an internal pressure of reagent gas in the vessel is above one atmosphere (absolute) based on a temperature of the vessel.

In yet another aspect the disclosure relates to a method of monitoring pressure of reagent gas in a vessel. The method includes: providing a vessel as described herein, and monitoring pressure of reagent gas in the vessel by observing the indicator.

In still another aspect, the disclosure relates to a storage and dispensing vessel for storing and dispensing reagent gas. The vessel includes: an interior volume; reagent gas within the interior volume; an exterior surface; and a reversible thermochromic indicator in thermal contact with the exterior surface. The thermochromic indicator reversibly indicates whether an interior pressure of the vessel is above a predetermined maximum desired pressure.

### BRIEF DESCRIPTION OF THE DRAWINGS

FIG. 1 illustrates a relationship between pressure and temperature of an exemplary general gaseous reagent gas in a vessel as described.

FIG. 2 illustrates an example of a thermochromic indicator in the form of a label at different temperatures.

FIG. 3 illustrates an example embodiment of a storage and dispensing vessel as described.

### DETAILED DESCRIPTION

The present description relates to novel and storage vessels and methods of their use. The vessels include a thermochromic indicator that is effective to convey information about the pressure of gaseous contents within the vessel to a location that is external to the vessel. The thermochromic indictor can be used in methods for handling, storing, using, and supplying gases, e.g., hazardous reagent gases, which are contained by the vessel with an increased level of safety, by identifying by a change in appearance whether pressure of gas contained in the vessel exceeds a pre-determined desired maximum pressure.

Gas contained by a storage and delivery vessel may be desirably contained in the vessel with the gas being present at a pressure that is below a pre-determined desired maximum pressure. The pre-determined desired maximum pressure is understood to occur at a specific temperature (which can be referred to herein as a “transition temperature,” see supra). The desired maximum pressure may be selected (i.e., pre-determined) by a user of the thermochromic indicator, e.g., a manufacturer or user of the vessel, and may generally be any desired maximum pressure that should not be exceeded by a user or handler of the vessel. The desired maximum pressure may be a pressure that causes in a safety hazard, a pressure that is too high for use of the gas by a particular process or tool, or any other pressure that a supplier of the vessel recommends as a maximum.

According to the present description, a thermochromic indicator can be included with and in thermal contact with a vessel, to indicate visually whether a pressure within the vessel is above or below the desired maximum pressure. The thermochromic indicator can change in appearance at a temperature at which the desired maximum pressure occurs, taking on a first appearance at a temperature that is below the temperature associated with the desired maximum pressure, and taking on a second appearance when the temperature of the vessel exceeds the desired maximum pressure. For added safety, the thermochromic indicator may be selected to change appearance at a temperature that is slightly below the desired maximum pressure.

The vessel includes sidewalls and an interior and can be of a type that is known for use in the storage, handling, and delivery of reagent gases, at any pressure. The sidewalls are designed to withstand a pressure that safely exceeds a desired maximum pressure recommended of a gas contained by the vessel.

Certain example storage vessels as described include adsorbent material at an interior of the vessel, and reagent gas at the interior. In thermal communication with the vessel is a thermochromic indicator that is useful in a novel and method of conveying information relating to the pressure of the reagent gas within the storage vessel, based on temperature, to a location at the exterior of the vessel. The vessel, and the novel methods of communicating information about the internal pressure of the reagent gas in the vessel, allow for novel and methods for handling, storing, using, processing, and supplying reagent gases including but not limited to hazardous reagent gases, at an increased level of safety.

Example vessels include sidewalls that are sufficiently rigid to contain a reagent gas and adsorbent as described herein, at an interior pressure that is at least a moderate level, e.g., at a pressure below about 3 atmospheres, absolute, or that is at least equal to an equilibrium pressure of an adsorbent at 55 degrees Celsius. Preferred sidewalls are sufficiently strong to withstand much higher pressures and are designed to be highly durable, to prevent damage and breach of the sidewalls during handling, use, storage, and transport, etc. The sidewalls are rigid, optionally cylindrical, and can be made of a strong and rigid material such as a metal or reinforced plastic. Many varieties and sizes of cylindrical storage vessels such as these are very well known.

In certain example vessels, the interior of the vessel contains gaseous reagent gas that is at a pressure that is below atmospheric pressure (a sub-atmospheric pressure) when the vessel is at an ambient temperature at a location for use of the reagent gas, e.g., at a desired operating temperature. The ambient temperature and operating temperature can be any temperature at which a vessel is used to handle, store, process, transport, or use a reagent gas, in any particular and relevant industry or application. Example operating temperatures for applications at which a reagent gas is used at approximately room temperature can be approximately a room temperature of the environment of use, e.g., 24 degrees C., e.g., in a range from about 20 to about 26 degrees Celsius. Vessels and methods of the present description will also be useful at higher and lower operating temperatures, as desired, for applications that use, hold, store, or process a reagent gas at a significantly higher or a significantly lower temperature.

By providing a sub-atmospheric pressure of the reagent gas in the vessel at an operating temperature, the risk of leaks and bulk dispersion of the reagent gas into the ambient environment is reduced as compared to the use of other types of vessels known for use to store and handle reagent gases under pressure, e.g., high pressure, which entail a constant and significant risk and corresponding safety and handling concerns because of the pressurized hazardous gas reagent. According to the disclosure, the internal pressure of a vessel such as these can be monitored by use of a thermochromic indicator at a location of the vessel exterior, to confirm during preparation, storage, processing, or other handling or use of the reagent gas, that the reagent gas within the vessel is indeed at a sub-atmospheric pressure.

The vessel can be closed, but usually includes an opening that selectively allows for reagent gas to be added to or removed from the vessel interior, such as a discharge port that may include a valve that can be opened and closed. Attached to the valve at the discharge port may be a flow or pressure-regulating mechanism such as a pressure valve or a flow metering device. For example, the vessel, at an opening and discharge port, may be coupled to a valve head that can be opened and closed to allow reagent gas to be dispensed from the interior of the vessel through the dispense port and valve head. To achieve a desired pressure or flow rate of the flow of reagent gas from the vessel, a pressure regulator, flow meter, or other flow-regulating device may be at the valve head external to the vessel interior.

Alternately or additionally, one or more pressure regulator, flow meter, or other flow-regulating device may optionally be connected to the vessel opening but internal to the vessel, at the vessel interior; an internal flow-regulating mechanism at an interior of the vessel is not required and may be excluded from a vessel of the present description. According to certain example embodiments of described vessels and methods, a flow-regulating mechanism may be designed to operate at a pressure that is below one atmosphere, to allow reagent gas to be removed from the vessel interior at sub-atmospheric pressure. Examples of fluid supply vessels and appurtenant items such as flow valves and pressure valves of types that may be useful in a general sense according to the present description, are described, e.g., in U.S. Pat. 6,132,492 and in PCT Patent Publication WO 2017/008039, the entire contents of these documents being incorporated herein by reference.

Example vessels as described can contain adsorbent, (a.k.a. a solid-phase physical sorbent medium) at the vessel interior. The adsorbent has a sorptive affinity for one or more reagent gases such as one or more hazardous reagent gases. As such, the adsorbent can be useful for selectively, e.g., reversibly, adsorbing and desorbing reagent gas onto the adsorbent to allow the reagent gas to be: first delivered into the vessel in a manner to cause the reagent gas to adsorb onto the adsorbent; then to allow the adsorbed reagent gas (in equilibrium with an amount of desorbed, gaseous, reagent gas also at the vessel interior) to be stored within the closed vessel interior at approximately atmospheric pressure, preferably at sub-atmospheric pressure; and eventually to allow the reagent gas to be desorbed (e.g., under vacuum) from the adsorbent and removed from the vessel through an opening in the vessel, as gaseous reagent gas, preferably still at approximately atmospheric pressure, e.g., at sub-atmospheric pressure.

The adsorbent may be any known or future-developed adsorbent, and a particular adsorbent of a vessel may depend on factors such as the type and amount of reagent gas to be contained in the vessel, the volume of the vessel, among other factors. Various adsorbent materials are known in the reagent gas and reagent gas storage arts, and will be understood to be useful as an adsorbent in a vessel as described. Certain examples of adsorbent materials are mentioned in U.S. Pat. 5,704,967 (the entirety of which is incorporated herein by reference), U.S. Pat. No. 6,132,492 (mentioned previously) and in PCT patent publication WO 2017/008039 (also mentioned previously).

Non-limiting examples of adsorbent material that are known and that may be suitable for use in a vessel as described herein include: polymeric adsorbents such as microporous TEFLON, macro-reticulate polymers, glassy domain polymers; aluminum phosphosilicate (ALPOS); clays; zeolites, metal-organic frameworks, porous silicon; honeycomb matrix materials; activated carbon; and other carbon materials, and other similar materials. Some examples of carbon adsorbent materials include: carbon formed by pyrolysis of synthetic hydrocarbon resins such as polyacrylonitrile, sulfonated polystryrene-divinylbenzene, etc.; cellulosic char; charcoal; activated carbon formed from natural source materials such as coconut shells, pitch, wood, petroleum, coal, etc.

An exemplary vessel as described may be substantially filled with a bed of suitable adsorbent material. The adsorbent may be in any shape, form, size, etc., to efficiently and reversibly adsorb reagent gas onto the adsorbent for storage in the vessel at sub-atmospheric pressure. The size, shape, and physical properties such as porosity can affect the capacity of the adsorbent (to adsorb reagent gas) as well as the packing density and void (interstitial space) volume of the adsorbent, and these factors can be selected based on a balance of factors of a storage vessel system including the type of reagent gas, the type of adsorbent, operating temperature of the vessel, among others. The adsorbent material may have any suitable size, shape, porosity, range of sizes, and size distribution. Examples of useful shapes and forms include beads, granules, pellets, tablets, shells, saddles, powders, irregularly-shaped particulates, pressed monoliths, extrudates of any shape and size, cloth or web form materials, honeycomb matrix monolith, and composites (of the adsorbent with other components), as well as comminuted or crushed forms of the foregoing types of adsorbent materials.

These types of example vessels contain at the interior, the adsorbent, bearing a physically adsorbed reagent gas, in equilibrium with the reagent gas in gaseous form. The reagent gas (in any type of vessel, at any pressure) may be a hazardous reagent gas of a type that is known to be noxious, poisonous, or otherwise a safety risk. Toxic and other hazardous specialty gases are used in a number of industrial applications, such as for uses that include: ion implantation, epitaxial growth, plasma etching, reactive ion etching, metallization, physical vapor deposition, chemical vapor deposition, photolithography, cleaning, and doping, with these uses being part of the manufacture of semiconductor, microelectronic, photovoltaic, and flat-panel display devices and products. However, the use of a vessel or method as described can be applied to reagent gases being used in other applications and in other industries, because the improved level of safety provided by the methods and vessels applies to reagent gases and vessels generally, in any commercial or industrial context, and when used for any purpose or application.

The described vessels and method are useful with any reagent gas, particularly those that are hazardous, noxious, or otherwise dangerous. Yet the utility of the presently described vessels and methods are not limited to particular reagent gases or gases contained at a low to moderate pressure (e.g., about 1 atmosphere). Illustrative examples of reagent gases for which the described vessels and methods are useful include the following non-limiting gases: silane, methyl silane, trimethyl silane, hydrogen, methane, nitrogen, carbon monoxide, diborane, arsine, phosphine, phosgene, chlorine, BCl₃, BF₃, B₂ D₆, tungsten hexafluoride, hydrogen fluoride, hydrogen chloride, hydrogen iodide, hydrogen bromide, germane, ammonia, stibine, hydrogen sulfide, hydrogen cyanide, hydrogen selenide, hydrogen telluride, deuterated hydrides, trimethyl stibine, halide (chlorine, bromine, iodine, and fluorine), gaseous compounds such as NF₃, ClF₃, GeF₄, SiF₄, AsF₅, organo compounds, organometallic compounds, hydrocarbons, and organometallic Group V compounds such as (CH₃)₃Sb. For each of these compounds, all isotopes are contemplated.

According to the present description a thermochromic indicator such as, for example, a label, paint, coating, or other item that contains a temperature-indicative material such as a thermochromic dye, ink, or the like can be used to identify and convey information relating to a pressure of reagent gas within a vessel, based on temperature of the vessel. Generally, the information relating to the reagent gas pressure can be useful to identify whether reagent gas (e.g., hazardous reagent gas) is at a pressure that is higher than a desired maximum pressure, and, therefore, should be treated as a greater safety hazard and with additional care or caution compared to the same vessel containing the same reagent gas at a pressure that is below a desired maximum pressure. In example methods, the thermochromic indicator (and a temperature-indicative material of the thermochromic indicator) can be selected to exhibit an activation temperature that will cause the temperature-indicative material and the thermochromic indicator to take on a first appearance (e.g., color) when at a first temperature that is below a temperature that produces a desired maximum pressure of reagent gas in a vessel, and to take on a second appearance (e.g., color) when at a second temperature that is above the temperature that produces a desired maximum pressure of reagent gas in a vessel.

In specific example embodiments of vessels and methods of the present description, the information relating to the reagent gas pressure can be useful to identify whether reagent gas (e.g., hazardous reagent gas) is at a pressure that exceeds atmospheric pressure, i.e., a super-atmospheric pressure, and, therefore, should be treated as a greater safety hazard compared to the same vessel containing the same reagent gas at sub-atmospheric pressure. In example methods, the thermochromic indicator (and a temperature-indicative material of the thermochromic indicator) can be selected to exhibit an activation temperature that will cause the temperature-indicative material and the thermochromic indicator to take on a first appearance (e.g., color) when at a first temperature that is below the transition temperature (which in this example is a temperature that results in an internal pressure of one atmosphere) of a system of a vessel, adsorbent, and reagent gas, and to take on a second appearance (e.g., color) when at a second temperature that is above the transition temperature.

The thermochromic indicator can be affixed to an external location of the vessel and is in thermal communication with the sidewalls or interior of the vessel, i.e., can take on the temperature of the sidewall or interior of the vessel. Desirably, hazardous reagent gases can be safely stored at sub-atmospheric pressure so that in the event of a breach of the vessel, the contained reagent gas in gaseous form is less prone to be released from the vessel. Therefore, according to these example methods, vessels, and thermal indicators, the thermochromic indicator is used to convey information about whether the internal pressure of a vessel is above or below one atmosphere.

Within an exemplary vessel, reagent gas can be in a form that includes a portion that is in a gaseous form, i.e., as gaseous reagent gas. At generally ambient temperatures that may be in a range of operating temperatures of a vessel (e.g., temperatures in a range from about 0 to about 30 or 40 degrees Celsius), the vessel (i.e., the gaseous reagent gas) is not highly pressurized and is preferably at a pressure that is in a range of about one atmosphere (absolute), e.g., in a range of from 0.5 to 1.0, 1.5, 2.0 or 3.0 atmospheres (absolute).

If a temperature of contained reagent gas in a vessel is below a transition temperature, the thermochromic indicator will have an appearance and will display a color or other information such as opacity or colored text that indicates that the gaseous reagent gas in the vessel is contained at a pressure that is below the pressure associated with the transition temperature. The user will recognize that the vessel has a desirably low (e.g., sub-atmospheric) internal pressure, and may proceed to handle and use the vessel with a standard, high level of care.

If, however, a temperature of a contained reagent gas is above a transition temperature, meaning that gas contained in the vessel will be at a pressure that is above a desired maximum pressure, the thermochromic indicator takes on an appearance and display a color, opacity, or other information such as text, that indicates that the gaseous reagent gas in the vessel is contained at an undesirably high pressure, e.g., is over-pressurized. The user of the vessel views the thermochromic indicator and recognizes that the vessel is at a temperature that results in an over-pressurized vessel interior, which is known to be an increased safety hazard. In response, the user will understand or will be instructed to perform an extra handling step to reduce the internal pressure of the vessel by reducing the temperature of the vessel and its contents, to thereby reduce the pressure to a pressure that does not exceed the desired maximum pressure. After the user cools the temperature of the vessel to temperature that is below the transition temperature, reducing the pressure of the vessel to below the desired maximum pressure, the user will know to handle and use the vessel as desired and with a standard, high level of care.

The thermochromic indicator may be made with a temperature-indicative material in the form of a temperature-indicative dye or ink, e.g., a leuco-dye, a liquid crystal slurry, or another organic dye or chemical compound or material that reversibly changes a visually-observable feature of its appearance (e.g., color, opacity, etc.) when a temperature of the temperature-indicative material is increased or decreased from a temperature below an activation temperature of the material to a temperature above the activation temperature, and from a temperature that is above the activation temperature to a temperature that is below the activation temperature.

The thermochromic indicator can be prepared with the temperature-indicative material formed into a plain, solid field, or in a pattern, which can be in the form of text or a representative symbol (e.g., hazard warning), any of which can indicate whether reagent gas contained in a vessel to which the thermochromic indicator is attached is at a desirably low pressure, below a desired maximum pressure. The thermochromic indicator can be positioned and viewable at a location on an exterior of the vessel, to externally convey information relating to the internal pressure of the vessel by conveying a certain appearance (e.g., color or message in color) that indicates whether contained reagent gas is at a pressure that is above or below a desired maximum pressure. Under normal conditions, with the contents at a pressure that is below a desired maximum pressure (e.g., at a sub-atmospheric temperature), the thermochromic indicator has an appearance such as a color or a displayed message that indicates that the pressure within the vessel is not above the desired maximum pressure and can be handled, moved, stored, or used according to standard precautions. The thermochromic indicator has a different appearance (e.g., color or message) if the contents are at a temperature that causes an internal pressure within the vessel that is above the desired maximum pressure.

The thermochromic indicator can include a temperature-indicative material that is selected to change from having a first appearance (e.g., a first color and optional message) indicating a desirably low (e.g., sub-atmospheric) pressure, to a second appearance (e.g., a second color and optional message) indicating an undesirably high (e.g., super-atmospheric) pressure, at a desired activation temperature, i.e., at (or approximately at, but below) a transition temperature, T_{Tra}, of a system of a vessel, reagent gas, and adsorbent. The temperature indicative-material and the activation temperature of the material, i.e., the temperature at which the temperature-indicative material changes with respect to a visually-observable appearance (e.g., color or opacity), can be selected based on the transition temperature of a system, e.g., a temperature associated with a desired maximum pressure, or a temperature that is slightly below the transition temperature. For a system that includes adsorbent and reagent gas in a closed vessel, having a desired maximum pressure of one atmosphere or slightly below, an activation temperature may be a temperature at which a pressure within the vessel is 0.8, 0.85, 0.9, or 0.95 atmosphere (absolute).

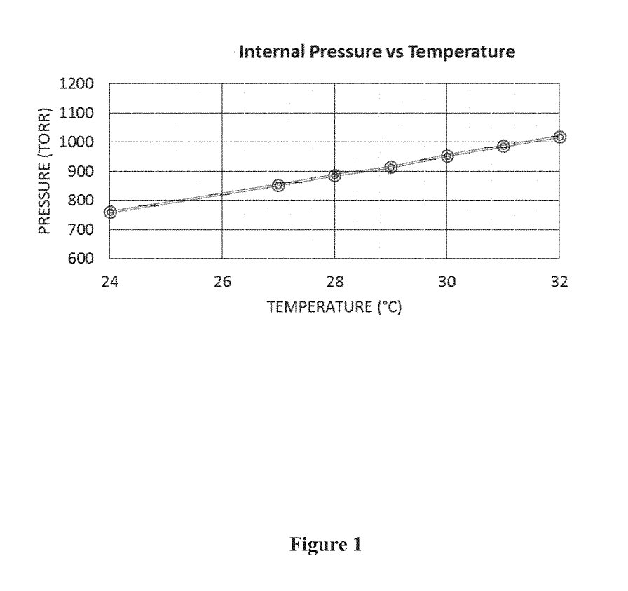

Referring to FIG. 1, illustrated is a graph that displays pressure of a reagent gas in a vessel, with adsorbent, relative to temperature of the gas (and vessel). The vessel is adapted for use at an operating temperature in a range of normal room temperature, e.g., in a range of approximately about 24 degrees Celsius; the transition temperature (in this instance, the temperature at which the vessel interior is one atmosphere) of the reagent gas is 24 degrees Celsius, i.e., the reagent gas pressure is one atmosphere (760 torr, absolute) at 24 degrees Celsius. Above the transition temperature the pressure of the reagent gas is above one atmosphere, absolute. At a temperature that is below 24 degrees Celsius the reagent gas will be at a sub-atmospheric pressure, below one atmosphere, absolute. An activation temperature of a thermochromic indicator for this system may be selected based on the transition temperature, i.e., the temperature at which the vessel interior is at a pressure of one atmosphere, i.e., 24 degrees Celsius. A useful activation temperature may be 24 degrees Celsius, or a temperature that is slightly below 24 degrees Celsius, such as a temperature at which the reagent gas will be contained in the vessel at a pressure of 0.8, 0.85, 0.9, or 0.95 atmosphere.

The thermochromic indicator may be in the form of a label, paint, coating, or the like, that contains a temperature-indicative material that has one appearance (e.g., one color, optionally in the form of a message, in written text) when the temperature-indicative material is at a temperature below a transition temperature, T_{Tra}, and a different appearance (e.g., color) when the temperature-indicative material is above the transition temperature, T_{Tra}. For systems having a transition temperature associated with a vessel internal pressure of one atmosphere, a first appearance (e.g., color, optionally patterned as a first message), i.e., a sub-atmospheric appearance (e.g., color and optional message) is shown by the thermochromic indicator when the vessel and its contents are at a sub-atmospheric temperature, T_{Sub}. A second appearance (e.g., color, optionally patterned as a second message), i.e., a super-atmospheric appearance (e.g., second color and optional second message), is shown by the thermochromic indicator when the vessel and contents are at a super-atmospheric temperature, T_{Sup}.

To display information relating to internal pressure of a vessel, the thermochromic indicator may include a change of appearance that may be a simple color change. The indicator may appear as a first color such as green (or another color, color including a state of opacity) for a pressure that is below a desired maximum pressure (e.g., for a sub-atmospheric pressure), and as a second color such as red or another color different from the first color, for a pressure that exceeds the desired maximum pressure (e.g., for a super-atmospheric pressure). Alternately, or in addition, the thermochromic indicator may be formed in a manner so that that one or more of the first color and the second color display one or more messages that are in the form of a symbol or text that may include, e.g., a message that: an added precautionary step is recommended, an increased risk or hazard exists, or that temperature of a vessel should be reduced before transporting or using the vessel. The indicator may be patterned to include a text message, such as “Recommended Pressure,” “Super-Atmospheric Pressure,” “Reduce Temperature,” “Elevated Temperature/Super-Atmospheric Pressure—Reduce Temperature of the Vessel Before Use or Transport” or the like, for example to indicate that the vessel includes reagent gas at a pressure that higher than a recommended pressure (desired maximum pressure), and not at a desirably low pressure as is intended and recommended for use, handling, storage, or transport of the vessel and reagent gas. A colored message of a thermochromic indicator can specifically, alternately and reversibly indicate to the user that the contained reagent gas is contained in the vessel at a pressure and temperature that is recommended for use, or that the contained reagent gas is at a pressure at which added caution and safety measures should be observed, such as by reducing the temperature of the vessel. After a user reduces the temperature of the vessel, the message conveyed by the thermal indicator will be changed to indicate that reagent gas is contained at desirably low or recommended (e.g., sub-atmospheric) pressure.

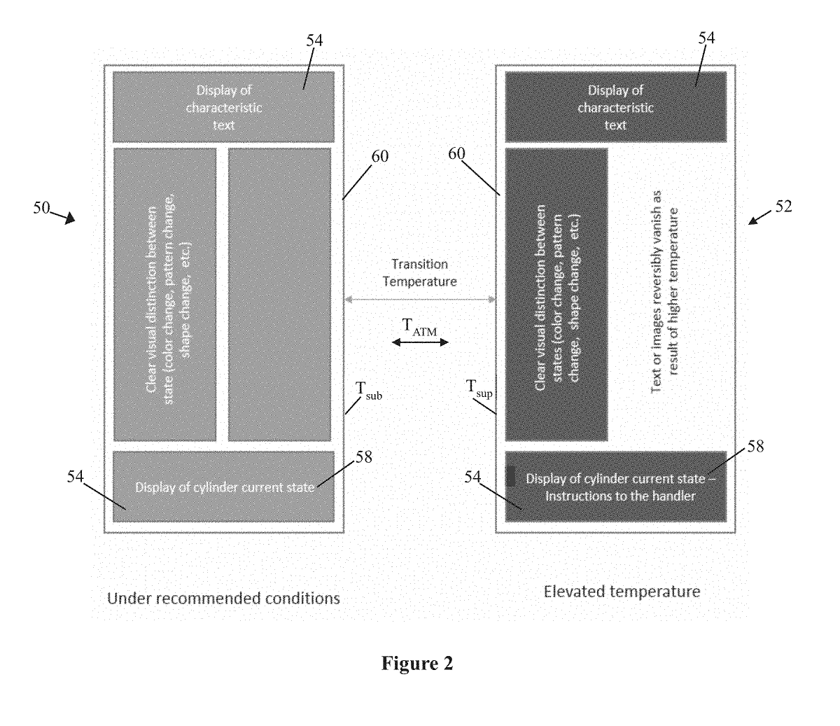

Referring to FIG. 2, a thermochromic indicator in the form of a paper slip or adhesive slip is shown. The label, 60, is shown at two temperatures. Label form 50 on the left is shown at a sub-atmospheric temperature, and label form 52 on the right is shown at a super-atmospheric temperature. When label 60 is contacted with or adhered to a vessel (not shown) that contains adsorbent and reagent gas, and the temperature of the vessel is below an activation temperature of the thermochromic indicator (e.g., the temperature is at a transition temperature or slightly below), the reagent gas is at a sub-atmospheric pressure and label 60 will appear as label form 50. This label form includes fields 54 (among others) at the top and bottom of label form 50, both having a first color appearance. The bottom field 54 is a first color field with text indicating a state of a vessel is either as recommended, e.g., optimal or not otherwise in need of additional care. When label 60 is contacted with or adhered to the vessel and the temperature of the vessel is above an activation temperature of the thermochromic indicator (e.g., a transition temperature or slightly below), the reagent gas is at or near a super-atmospheric pressure and label 60 will appear as label form 52. Label form 52 includes fields 54 at the top and bottom of label form 52, appearing as a second color, each with optional text (as illustrated). The bottom field 54 is a field having a second color with a message in the form of writing (text 58) that notifies a user that the vessel is at a temperature that is too high and instructs the user to take action, such as to return the vessel to a recommended condition such as a recommended temperature. The top field 54 can also include text to describe a state of the vessel, e.g., a state of elevated temperature, pressure, or of a need for additional precaution in handling the vessel. Two additional optional fields are also shown on label 60: a left-vertical field between top and bottom fields 54, and a right-vertical field between top and bottom fields 54. Each of these additional fields can change in form between temperatures that are above and below a transition temperature, e.g., by changing in color, by changing exhibit visible or non-visible text, or both.

The temperature-indicative material may be any type of temperature-indicative material that can change in appearance, e.g., in color, in response to a temperature change, such as any of known and various chemical indicators, thermochromatic inks, leucodyes, fusible materials, other similar materials that change form (e.g., color or opacity) based on temperature. For example, a temperature-indicative material may include a temperature sensitive chemical indicator or thermochromic or thermochromatic ink. Thermochromic or thermochromatic ink is a type of dye that changes color when temperatures increase or decrease. In some instances, thermochromic or thermochromatic inks may comprise leucodye. Once heated, the temperature-indicative material melts and dissolves the dye, resulting in a change in color or the appearance of the temperature-indicative material. Upon cooling, the temperature-indicative material re-crystallizes and the color reverts back to the original color. A thermochromatic ink may be any of various inks that are well-known and commercially available. Additionally, for example, a temperature-indicative material may include a fusible material. When exposed to a change in temperature, the fusible material fuses and becomes transparent or opaque.

In combination, a storage and delivery system of the present description may usefully contain or consist of a standard gas cylinder or other pressurizable vessel, and a cylinder valve or other flow dispensing assembly (regulators, monitors, sensors, flow directing means, pressure controllers, mass flow controllers, piping, valving, instrumentation, automatic start and shut-off devices, etc.) coupled to the vessel, with the cylinder holding the adsorbent material and reagent gas, the reagent gas being in a state of equilibrium between adsorbed sorbent gas and gaseous sorbent gas.

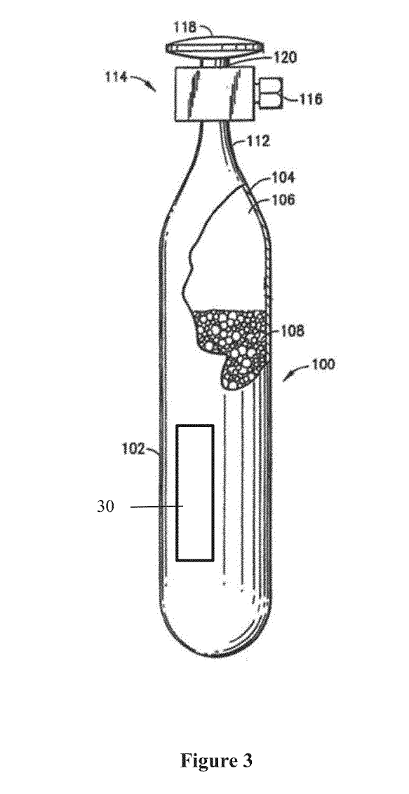

FIG. 3 illustrates an exemplary storage and dispensing system 100, which includes vessel 102 that contains adsorbent material 108 within interior 106 of the vessel. Sidewalls 104 define the interior space and an exterior surface. Upper end 112 includes an opening with valve assembly 114, which includes threaded coupling 116, valve 120, and knob 118 to open and close valve 120 to allow for removal of reagent gas from the vessel. Gaseous reagent gas (not specifically numbered) is present as a gas in interior 106, and is in equilibrium with adsorbed reagent gas that is physically adsorbed to surfaces of adsorbent material 108. Reversible thermochromic indicator 130 is in contact with the external surface of sidewalls 104. Indicator 130 can be as described herein, and can exhibit a first appearance (e.g., color) when vessel 102 is at a temperature that is below a transition temperature, and a second appearance (e.g., color) when vessel 102 is at a temperature that is above a transition temperature. An example of reversible thermochromic indicator 130 is label 60 of FIG. 2.

In use, reagent gas (e.g., the gaseous reagent gas and the adsorbed reagent gas) can be removed from exemplary vessel 102 by pressure differential desorption, meaning by connecting coupling 116 to a source of reduced pressure to cause gaseous reagent gas to flow through valve assembly 114 to a location external to interior 106. The contained reagent gas can be any reagent gas material, especially a hazardous reagent gas, which is used or useful in any industry, especially in the manufacture of semiconductor, microelectronic, photovoltaic, and flat-panel display devices and products. System 100 may be connected to a system that uses the reagent gas as a raw material for processing a semiconductor device or material, a microelectronic device, a photovoltaic device, a flat-panel display device, or a component or precursor thereof, e.g., a system, device, or tool used for: ion implantation, epitaxial growth, plasma etching, reactive ion etching, metallization, physical vapor deposition, chemical vapor deposition, photolithography, cleaning, or doping.

What is claimed is:

1. A storage and dispensing vessel for storing and dispensing reagent gas, the vessel comprising:
an interior volume,
adsorbent within the interior volume,
reagent gas within the interior volume, the reagent gas comprising a portion that is adsorbed on the adsorbent as adsorbed reagent gas, and a portion that is present as gaseous reagent gas in equilibrium with the adsorbed reagent gas,
an exterior surface, and
a reversible thermochromic indicator in thermal contact with the exterior surface, the thermochromic indicator reversibly indicating whether an interior pressure of the vessel is above a desired maximum pressure that is associated with a transition temperature.

2. A vessel of claim 1 wherein the indicator has an appearance at one or more temperatures below the transition temperature, and the indicator has a different appearance at temperatures above the transition temperature.

3. A vessel of claim 2 wherein the transition temperature corresponds to a vessel pressure of one atmosphere.

4. A vessel of any of claim 1 wherein the indicator includes a temperature-indicative material that has a first appearance below an activation temperature and a second appearance above the activation temperature, and the activation temperature is the transition temperature or a temperature slightly below the activation temperature.

5. A vessel of claim 1 wherein the internal pressure of the vessel is in a range from 0.5 to 1.5 atmospheres.

6. A vessel of any of claim 1 wherein the transition temperature is a temperature in a range from about 20 to 29 degrees Celsius.

7. A vessel of any of claim 1 wherein the adsorbent is selected from a material comprising carbon, activated carbon, zeolite, and a metal-organic framework.

8. A vessel of any of claim 1 wherein the indicator comprises a multi-layer adhesive-coated label adhesively bonded to the exterior surface.

9. A vessel of any of claim 1 wherein the indicator comprises temperature-indicative material selected from a leuco dye and a liquid crystal thermochromic material.

12. A method of handling a vessel of any of claim 1, the method comprising:
observing the indicator to determine if the indicator indicates an internal pressure that is greater than the transition temperature, and if so, reducing the temperature of the vessel.

13. A method of any of claim 12 comprising maintaining the temperature of the vessel at a temperature below the transition temperature.

14. A method of claim 12 wherein the reagent gas is present within the interior volume at an internal pressure below about 3 atmospheres (absolute).
